(19) United States
(12) Patent Application Publication
(10) Pub. No.: US 2005/0035930 A1
(43) Pub. Date: Feb. 17, 2005

(54) Generation of falling edges with energy recovery in a plasma display

(76) Inventors: Jean-Raphael Bezal, Meylan (FR); Gerard Morizot, Voiron (FR); Philippe Marchand, Vitre (FR)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/915,606

(22) Filed: Aug. 9, 2004

(30) Foreign Application Priority Data
Aug. 14, 2003 (FR) 03/09967

(51) Int. Cl. G09G 3/28

(52) U.S. Cl. 345/60

(57) ABSTRACT

The invention relates to a device for driving a plasma display panel capable of generating a voltage falling edge on one of the electrodes of the display cells while maintaining a fixed potential on the other electrode of the display cells. This device is designed to be used at the end of the sustain phase of the display cells to bring the two cell electrodes back to a low potential. It comprises means for storing energy during a first time period of the falling edge and means for transferring the stored energy to the voltage supply source of the device during the remaining time period of said falling edge.

### FIELD OF THE INVENTION

The invention relates to a device for driving a plasma display panel capable of generating a voltage falling edge on one of the sustain Ys and address-sustain Yas electrodes of the cells of said display while maintaining a fixed potential on the other of said sustain and address-sustain electrodes. This device is especially, while not exclusively, designed to be used at the end of the sustain phase of the display cells to bring the two cell electrodes back to a low potential.

### BACKGROUND OF THE INVENTION

FIG. 1 describes a conventional sustain circuit for the electrical discharges in a plasma display panel. Such a circuit is notably described in the European Patent Application EP 0 704 834. This circuit comprises means 1 for applying a supply voltage Vs, alternately, to the sustain electrode Ys and the address-sustain electrode Yas of the plasma display cells and a circuit 2 designed to recover energy during the cell sustain phase.

The means 1 consist of four switches I1, I2, I3 and I4. Two switches, I1 and I2, are connected in series between a power supply terminal receiving a sustain voltage Vs and ground. The mid-point between these two switches is connected to the electrode Ys of the display cells. The two other switches, I3 and I4, are also connected in series between the power supply terminal receiving the sustain voltage Vs and ground. The mid-point between these two switches is connected to the address-sustain electrode Yas of the cells.

The energy recovery circuit 2 is connected between the electrodes Ys and Yas. It comprises an inductor L connected in series with a two-way switch between the electrodes Ys and Yas. The two-way switch is formed by a switch I5 in series with a diode D1 allowing the current to flow in one direction when the switch I5 is closed and, connected in parallel, by a switch I6 connected in series with a diode D2 allowing the current to flow in the opposite direction when the switch I6 is closed. Accordingly, when one or the other of the switches I5 and I6 is closed, the inductor L is connected in parallel with the capacitance C of the display (shown as a dotted line between the electrodes Ys and Yas) forming a resonant circuit with the latter. The detailed operation of this circuit is well known to those skilled in the art and is fully described in the European Patent Application EP 0 704 834. The energy recovery consists of a transfer of energy between the display capacitance and the inductor of the circuit 2 during voltage edges on the electrodes Ys and Yas. During a first edge, energy is transferred from the inductor to the capacitance of the display and, during the following edge, the energy transfer takes place in the opposite direction, i.e. from the capacitance to the inductor. Furthermore, as shown in FIG. 2, the energy recovery takes place during a symmetric inversion of the potentials on the electrodes Ys and Yas. For example, when the potential on the electrode Ys goes from Vs to 0, the inverse transition is effected on the electrode Yas which goes from 0 to Vs.

In the case where only the potential of one of the two electrodes Ys and Yas is to be inverted, the other electrode being maintained at a fixed potential, such as at the end of a sustain cycle where both electrodes are brought back to the same potential, this circuit no longer functions and the energy recovery is inoperative.

FIGS. 3 and 4 illustrate this impossibility. The case where the potential on the electrode Ys is 0 volts and that on the electrode Yas is Vs will be considered. It is then possible to close the switches T2 and T5 such that the capacitance C becomes resonant with the inductor L causing the potential on the electrode Yas to fall. This phase is illustrated by FIG. 3. As the capacitance C discharges into the inductor L, the potential of the electrode Yas decreases. When the potential on the electrode Yas reaches 0 volts, the current stored in the inductor L is maximal. It causes the closing of the switch I4 which is currently composed of a MOS transistor and its anti-parallel diode, thus creating a “flywheel” current within the current loop formed by the closed switches I2, I4, I5, the diode D1 and the inductor L, as shown in FIG. 4. The current stored in this loop could only be cancelled by dissipation in the loop components and this during a much too long time, which prevents from going to the next phases.

In addition, the cancellation of the current stored in the inductor: L takes causes heating of the circuit components with a risk of destroying them.

### SUMMARY OF THE INVENTION

The invention aims to overcome the aforementioned drawbacks.

Thus, the subject of the invention is a device for driving a plasma display panel comprising first means for generating a voltage falling edge on one of the sustain electrodes Ys and address-sustain electrodes Yas of the cells of said display, a fixed potential being maintained on the other of said sustain and address-sustain electrodes, characterized in that said first means store energy during a first time period of the falling edge and in that it additionally comprises second means for transferring the stored energy to the voltage supply source of the device during the remaining time period of said voltage falling edge.

This device is compatible with the conventional cell sustain circuit of the plasma display. Said first means can notably be used for the sustain of the display cells.

According to one particular embodiment, the first means of the device comprise an inductor of which a first end is connected to the electrode whose potential is decreased and a second end is connected to the electrode whose potential is kept fixed via a first diode connected in series with a switch, the anode of said first diode being on the side of said inductor, which switch is in a closed state during said first time period of the falling edge during which current is stored in the inductor and in an open state during the remaining time period of the falling edge during which the current stored in the inductor is transferred to the voltage supply source of the device. In this embodiment, the second means consist, for example, of a second diode connected between said second end of the inductor and the voltage: supply source of the device, the anode of said second diode being on the side of the second end of the inductor.

Advantageously, the device additionally comprises a third diode in series with a resistor, the anode of said third diode being on the ground side, the whole assembly being connected between the second end of the inductor and ground.

### BRIEF DESCRIPTION OF THE DRAWINGS

The invention will be better understood upon reading the description that follows, presented as a non-limiting example and with reference to the appended figures, in which:

FIG. 1, described above, shows the circuit diagram of a cell sustain circuit of a prior-art plasma display;

FIG. 2, described above, shows the voltages applied to the electrodes Ys and Yas of the plasma display cells by the sustain circuit in FIG. 1, together with the current flowing through the inductor L of the circuit during the voltage rising and falling edges;

FIGS. 3 and 4, described above, show the currents flowing in the circuit of FIG. 1 in the case where it is desired to decrease the voltage Vs to 0 volts on the electrode Yas of the display cells while simultaneously maintaining the electrode Ys at 0 volts;

FIG. 5 shows a circuit diagram of a device, according to the invention, capable of generating a voltage falling edge on one of the electrodes Ys or Yas of the display cells, while simultaneously maintaining a fixed potential on the other electrode;

FIG. 6 or 7 show the currents flowing in the circuit of FIG. 5 during the generation of the falling edge on the electrode Yas of the plasma display cells, the potential on the electrode Ys being maintained at 0 volts; and

FIG. 8 is a set of timing diagrams showing the behaviour of the currents and voltages in the elements of the circuit in FIG. 5 during the generation of a falling edge on the electrode Yas of the plasma display cells.

### DESCRIPTION OF PREFERRED EMBODIMENTS

According to the invention, the device for driving the plasma display panel comprises means for generating a voltage falling edge on one of the sustain electrodes Ys and address-sustain electrodes Yas of the cells of said display, said means being designed to maintain a low potential on the other of said sustain and address-sustain electrodes and to store energy during a first period part of the falling edge, and second means for transferring the energy stored in the first means to the voltage supply source of the device during the end part of the falling edge.

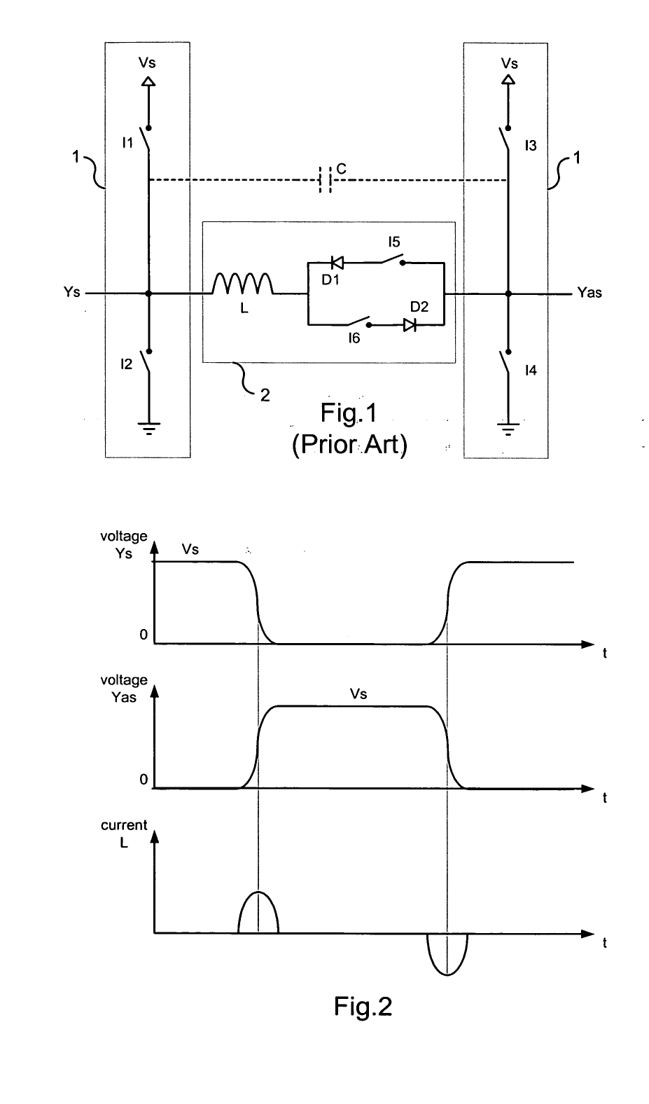

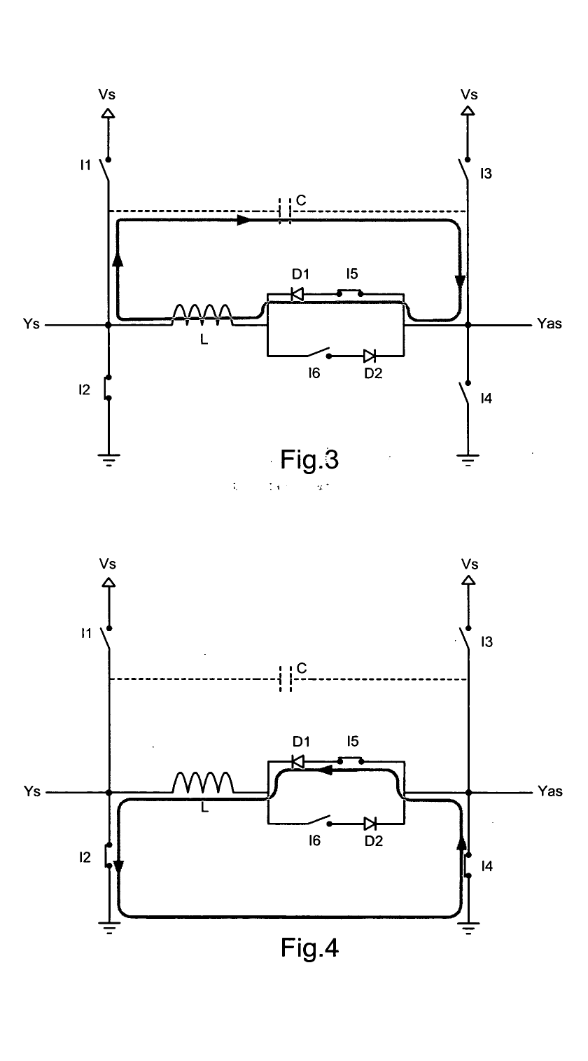

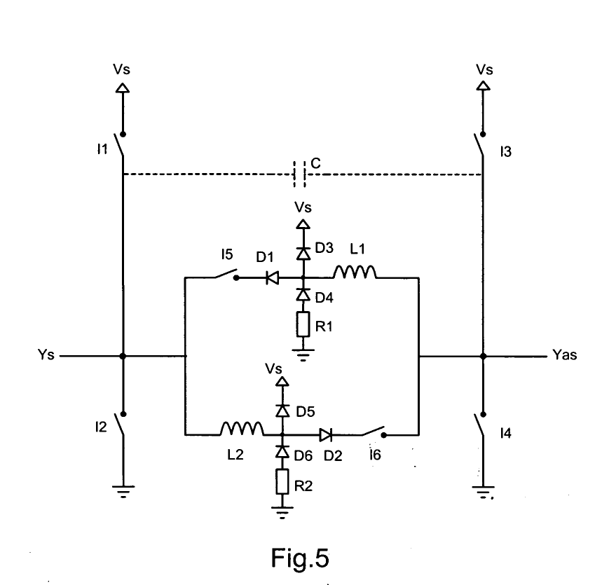

A circuit diagram of such a device is shown in FIG. 5. This device is compatible with the sustain circuit of a conventional plasma display since certain elements of the device of the invention are employed both for the cell sustain and for generating a falling edge such as is claimed. These elements are designated by the same references in FIG. 1 and in FIG. 5.

According to the invention, the driving device comprises an inductor L1 of which a first end is connected to the electrode Yas and a second end is connected to the electrode Ys via a diode D1 connected in series with a switch I5, the anode of the diode D1 being on the side of the inductor L1. These elements will be used to bring the potential of the electrode Yas down from Vs to 0, the potential of the electrode Ys already being at 0 volts, and to store current in the inductor L during a part of the falling edge. A diode D3, connected between the second end of the inductor L1 and the power source supplying the sustain voltage Vs, will be used to extract the stored current from the inductor L1 to said power source during: the end part of the falling edge. Advantageously, a diode D4 in series with a resistor R1 is connected between ground and the second end of the inductor 1L1, with its anode on the ground side. The purpose of this diode and this resistor is to remove the negative flywheel current which could appear in the inductor L1 during the conventional sustain cycles of the display cells.

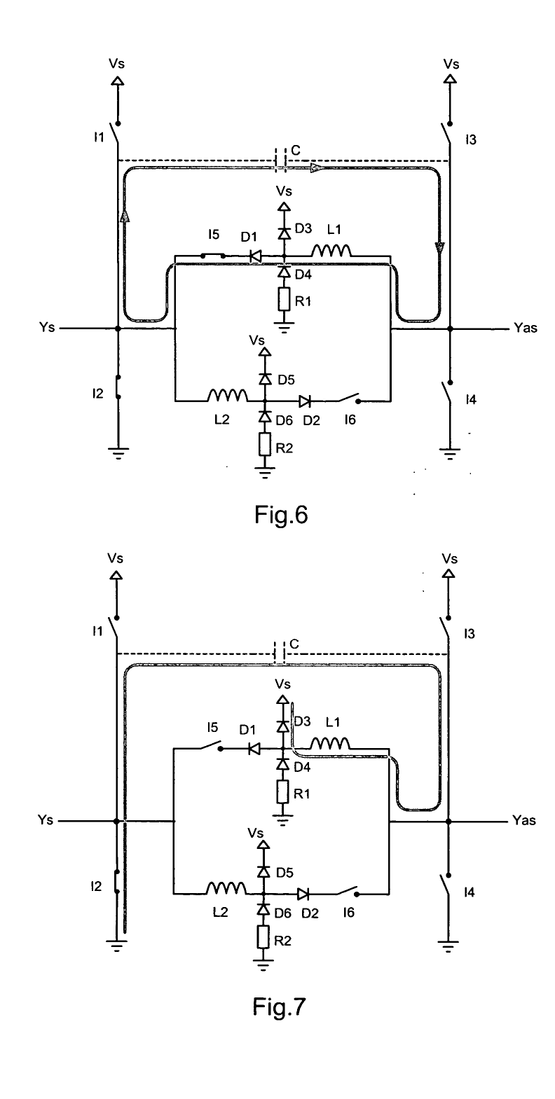

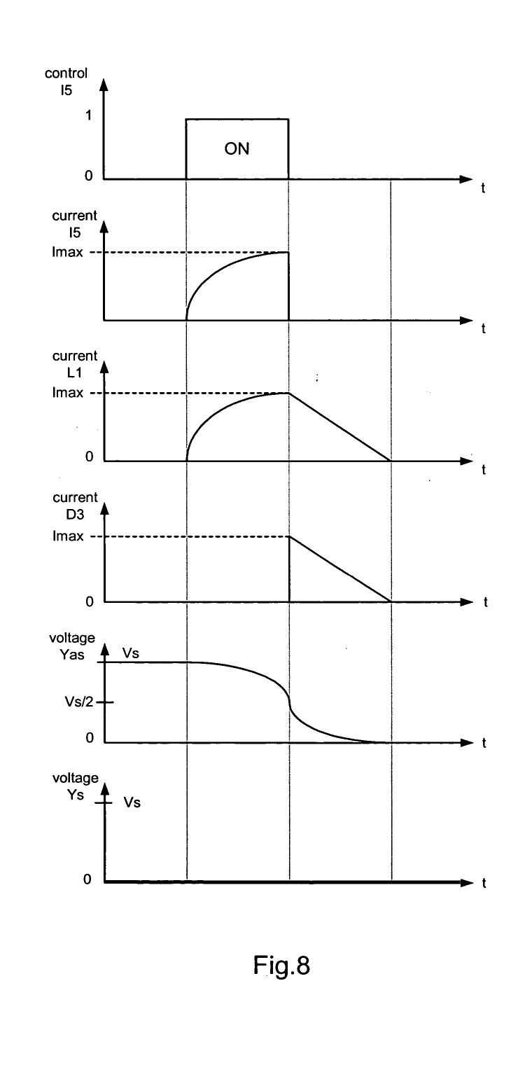

The operation of this part of the circuit will be illustrated in more detail by reference to FIGS. 6, 7 and 8 below.

The device of the invention also comprises means for generating a falling edge on the electrode Ys and for simultaneously maintaining a zero potential on the electrode Yas. For this purpose, the driving device also comprises an inductor L2 of which a first end is connected to the electrode Ys and a second end is connected to the electrode Yas via a diode D2 connected in series with a switch I6, the anode of the diode D2 being on the side of the inductor L2. A diode D5 is connected between the second end of the inductor L2 and the power source supplying the sustain voltage Vs. Additionally, a diode D6 in series with a resistor R2 is connected between ground and the second end of the inductor L2, with its anode on the ground side. The operation of this other part of the circuit is identical to that comprising the elements L1, D1, I5, D3, D4 and R1, but with the direction of the currents and the potentials on the electrodes Ys and Yas inverted.

With reference to FIGS. 6, 7 and 8, the part of the circuit comprising the elements L1, D1, I5, D3, D4 and R1 operates in the following manner. During a first part of the falling edge on the electrode Yas, illustrated in FIG. 6, the switch I5 is closed. A current loop is created through the inductor L1, the diode D1, the switch I5 and the display capacitance C. The inductor L1 becomes resonant with the display capacitance C and stores current up to a peak value Imax. The potential of the electrode Yas then decreases progressively. The switch I5 is then opened. As shown in FIG. 7, the current stored in the inductor L1 is then extracted into the power supply Vs via the diode D3. During this phase, the switch I2 is closed. A current loop through the inductor L1, the diode D3, the power source Vs, ground and the capacitance C is created. During this second period of operation, the potential of the electrode Yas continues to decrease to reach zero volts.

At the end of this second time period, the inductor L1 is fully discharged; current has been transferred to the power source of the device and the 2 electrodes Ys and Yas have reached zero potential.

As previously indicated, the elements L1, D1, I5 and L2, D2, I6 can be used for sustaining electrical discharges in the display cells as described in the document EP 0 704 834. The only difference is that the circuit now comprises two inductors, L1 and L2, each used in turn depending on the transition to be effected (0→Vs or Vs→0) instead of a single inductor, L, for all the transitions.

Apart from the fact that it allows energy recovery during falling edges on one of the electrodes of the display cells, this device presents the following advantages:
the elements L1, D1, I5, L2, D2 and I6 can be used as an energy recovery circuit (allowing energy to be transferred from the inductor to the display capacitance and vice versa) during the sustain phase of the plasma display cells;
little thermal losses are created;
its cost of implementation is very low given that it can also serve as an energy recovery circuit during the sustain phase of the display cells.

1. Device for driving a plasma display panel comprising first means for generating a voltage falling edge on one of the sustain electrodes and address-sustain electrodes of the cells of said display, a fixed potential being maintained on the other of said sustain and address-sustain electrodes, wherein said first means store energy during a first time period of the falling edge and in that said driving device additionally comprises second means for transferring said stored energy to the voltage supply source of the device during the remaining time period of said falling edge.

2. Device according to claim 1, wherein said first means comprise an inductor of which a first end is connected to the electrode whose potential is decreased and a second end is connected to the electrode whose potential is kept fixed via a first diode connected in series with a switch, the anode of said first diode being on the side of said inductor, which switch is in a closed state during said first time period of the falling edge during which current is stored in the inductor and in an open state during the remaining time period of the falling edge during which the current stored in the inductor is transferred to the voltage supply source of the device.

3. Device according to claim 2, wherein the second means consist of a second diode connected between said second end of the inductor and the voltage supply source of the device, the anode of said second diode being on the side of the second end of the inductor.

4. Device according to claim 3, wherein it additionally comprises a third diode in series with a resistor, the anode of said third diode being on the ground side, the whole assembly being connected between the second end of the inductor and ground.
